(19) United States
(12) Patent Application Publication
(10) Pub. No.: US 2012/0203520 A1
(43) Pub. Date: Aug. 9, 2012

(54) INPUT PARAMETER CALCULATION METHOD AND APPARATUS

(75) Inventor: Kazuhiro MATSUMOTO, Kawasaki (JP)

(73) Assignee: FUJITSU LIMITED, Kawasaki-shi (JP)

(21) Appl. No.: 13/308,915

(22) Filed: Dec. 1, 2011

(30) Foreign Application Priority Data
Feb. 3, 2011 (JP) 2011-022072

(51) Int. Cl. G06F 17/10

(52) U.S. Cl. 703/2

(57) ABSTRACT

This method includes calculating a support vector and first regression coefficient values by carrying out a regression calculation of a support vector machine for values of input variables and first values of an output variable; and calculating values of input parameters, which are to be used for a simulation, so as to minimize an error calculated from the first regression coefficient values and second regression coefficient values. The second regression coefficient values are obtained by the regression calculation of the support vector machine using the calculated support vector for second values of the output variable and the values of the input variables. The second values of the output variable are obtained from the simulation for the values of the input variables.

### CROSS-REFERENCE TO RELATED APPLICATIONS

This application is based upon and claims the benefit of priority of the prior Japanese Patent Application No. 2011-022072, filed on Feb. 3, 2011, the entire contents of which are incorporated herein by reference.

### FIELD

This technique relates to a technique for supporting a computer simulation.

### BACKGROUND

In the computer simulation such as a circuit simulation, as schematically illustrated in FIG. 1, typically, values of input parameters and values of input variables are inputted into a simulator in the computer to cause the simulator to execute the simulation according to a predetermined algorithm, and values of output variables are obtained as results of the simulation from the simulator. Because it is preferable that such results of the simulation are equal to measured values measured in actual circuits or the like, the values of the input parameters are adjusted so as to obtain, as the results of the simulation, the values of the output variables, which are closed to the actually measured values, as much as possible.

This adjustment is explained by using FIG. 2. In a graph in FIG. 2, the horizontal axis represents an input variable value, and the vertical axis represents an output variable value. In this example, values of the input variables and actually measured values of the output variables are represented by diamond-shaped points. Therefore, the input parameter values are adjusted so as to coincide these diamond-shaped points with a curve drawn as the simulation results. In this example, when the simulation is carried out by using “20” for the input parameter value, a curve “a” is drawn, and when the simulation is carried out by using “10” for the input parameter value, a curve “b” is drawn. Therefore, because the diamond-shaped points are on the curve “b”, which was obtained by using “10” for the input parameter, “10” is identified as an appropriate input parameter value, and is used for the simulation.

More specifically, as illustrated in FIG. 3, for example, a sum of squares of differences d1 to d5 between the actually measured value (diamond-shaped point) of the output variable and the value (curve “a”) of the output variable, which is obtained as the simulation result, is defined as an error, and a value of the input parameter minimizing this error is identified by an optimization algorithm.

However, according to such a simple method, a problem may occur in a following case. For example, as schematically illustrated in FIG. 4, an abnormal value “e” exists as the actually measured value (diamond-shaped point), and when the error becomes greater due to the abnormal value “e”, the different result may be obtained. In an example of FIG. 4, one point among 5 actually measured values is considered to be the abnormal value, and 4 remaining points are almost on a curve “d”. However, when the error is calculated according to the aforementioned definition, the error with respect to the curve “c” is the least as a whole. Therefore, the input parameter value for the curve “c” may be determined as the correct value. When the number of input variables and the number of output variables are “1” as illustrated in FIG. 4 and the human being sees the values, it is possible to recognize the existence of the abnormal value “e” and determine the value of the input parameter for the curve “d” as the correct value. However, it is not easy to determine whether or not the values of the input variables are abnormal values when the number of input variables is greater. Thus, when the actually measured values include the abnormal value, there is possibility that appropriate values of the input parameters cannot be identified.

Similarly, a similar problem may occur when the actually measured values widely vary. For example, as schematically illustrated in FIG. 5, when the actually measured values (diamond-shaped points) widely vary, it is difficult to evaluate which of a curve “f” with respect to the input parameter value “10” and a curve “g” with respect to the input parameter value “20” is appropriate, by using an indicator value other than the error.

Furthermore, when the distribution of the actually measured values has an offset, there is a case that it is impossible to correctly evaluate the fitting in the entire value range of the input variable. As schematically illustrated in FIG. 6, when a lot of actually measured values exist in a range that the input variable values are lesser, and actually measured values hardly exist in a range that the input variable values are greater, it is unknown that it can be said that a curve “h1” having the lesser error calculated according to the aforementioned definition is actually appropriate. In an example of FIG. 6, the actually measured values corresponding to the least input variable value and the greatest input variable value are on the curve “h2”. However, the actually measured values corresponding to the other input variable values are on the curve “h1”.

Namely, there is no conventional technique to derive appropriate input parameter values regardless of the distribution and/or states of the actually measured values.

### SUMMARY

According to a first aspect of this technique, a method for calculating values of input parameters includes: calculating a support vector and first regression coefficient values by carrying out a regression calculation of a support vector machine for values of input variables and first values of an output variable; and calculating the values of the input parameters, which are to be used for a simulation, so as to minimize an error calculated from the first regression coefficient values and second regression coefficient values, wherein the second regression coefficient values are obtained by the regression calculation of the support vector machine using the calculated support vector for second values of the output variable and the values of the input variables, and the second values of the output variable are obtained from the simulation for the values of the input variables.

According to a second aspect of this technique, a method for calculating values of input parameters includes: calculating a first approximate expression by carrying out a regression calculation of a support vector machine for first values of input variables and first values of an output variable; calculating second values of the output variable by substituting second values of the input variables into the first approximate expression; and calculating the values of the input parameters, which are to be used for a simulation, so as to minimize an error calculated from the second values of the output variable and third values of the output variable, wherein the third values are obtained by substituting the second values of the input variables into a second approximate expression, and the second approximate expression is obtained by the regression calculation of the support vector machine for the first values of the input variables and fourth values of the output variable, which are obtained from the simulation for the first values of the input variables.

According to a third aspect of this technique, a method for calculating values of input parameters includes: calculating a first approximate expression by carrying out a regression calculation of a support vector machine for first values of input variables and first values of an output variable; and calculating the values of the input parameters, which are to be used for a simulation, while randomly changing second values of the input variables so as to minimize an error calculated from second values of the output variable and third values of the output variable, wherein the second values of the output variable are obtained by substituting the second values of the input variables into an second approximate expression calculated by the regression calculation of the support vector for the first values of the input variables and fourth values of the output variable, and the fourth values of the output variable are obtained from the simulation for the first values of the input variables, and the third values of the output variable are calculated by substituting the second values of the input variables into the first approximate expression.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram to explain a related art;

FIG. 2 is a diagram to explain a related art;

FIG. 3 is a diagram to explain a related art;

FIG. 4 is a diagram to explain a problem of a related art;

FIG. 5 is a diagram to explain a problem of a related art;

FIG. 6 is a diagram to explain a problem of a related art;

FIG. 7 is a functional block diagram of an input parameter calculation apparatus relating to an embodiment;

FIG. 8 is a diagram depicting an example of data stored in a first data storage unit;

FIG. 9 is a diagram depicting a processing flow relating to the first embodiment;

FIG. 10 is a diagram to explain a support vector;

FIG. 11 is a diagram to explain a support vector;

FIG. 12 is a diagram depicting the processing flow relating to the first embodiment;

FIG. 13 is a diagram illustrating an example of data stored in a second data storage unit;

FIG. 14 is a diagram depicting a processing flow relating to the second embodiment;

FIG. 15 is a diagram to explain the second embodiment;

FIG. 16 is a diagram illustrating an example of data stored in the second data storage unit;

FIG. 17 is a diagram depicting a processing flow relating to the second embodiment;

FIG. 18 is a diagram depicting a processing flow relating to a third embodiment;

FIG. 19 is a diagram depicting the processing flow relating to the third embodiment;

FIG. 20 is a diagram depicting an example of data stored in the second data storage unit;

FIG. 21 is a diagram to explain the third embodiment;

FIG. 22 is a functional block diagram of a computer; and

FIG. 23 is a functional block diagram of the input parameter calculation apparatus.

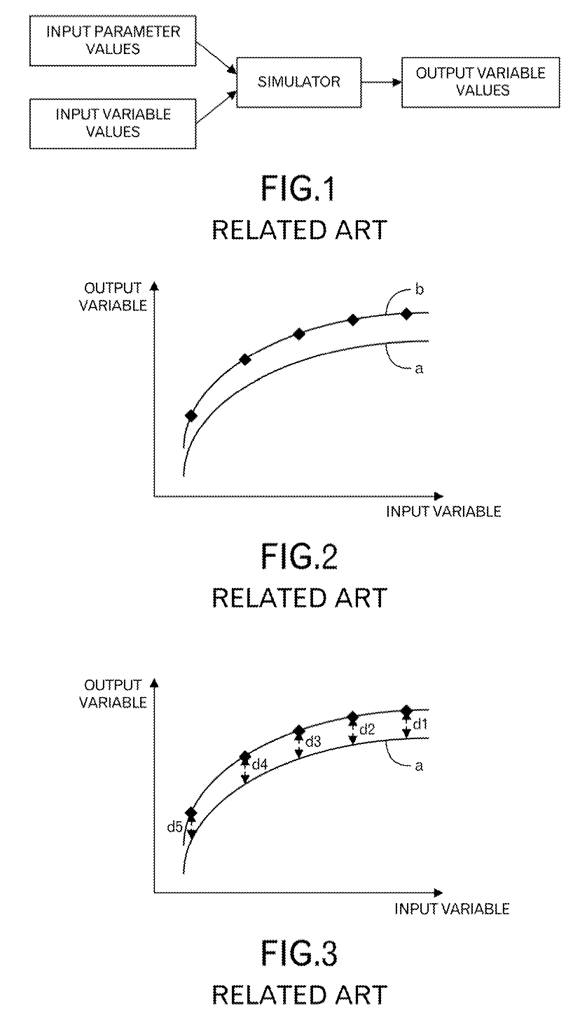

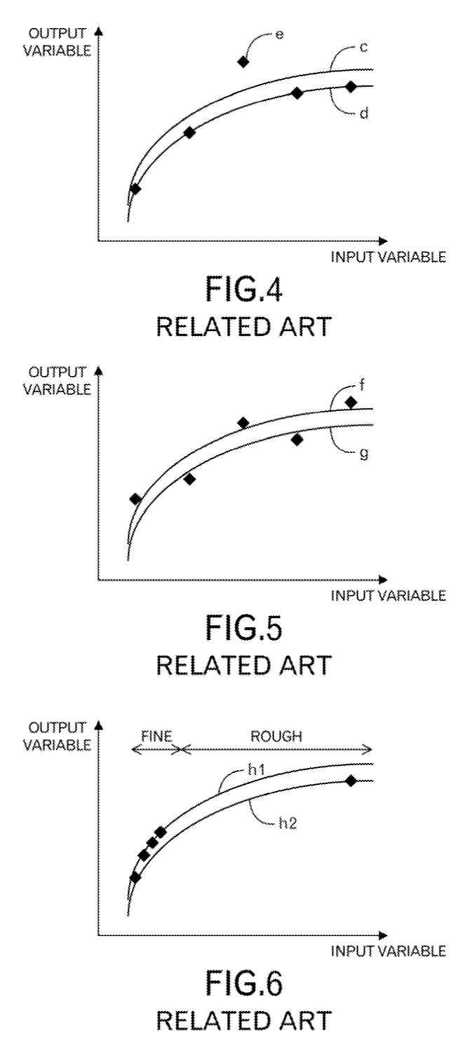

### DESCRIPTION OF EMBODIMENTS

### Embodiment 1

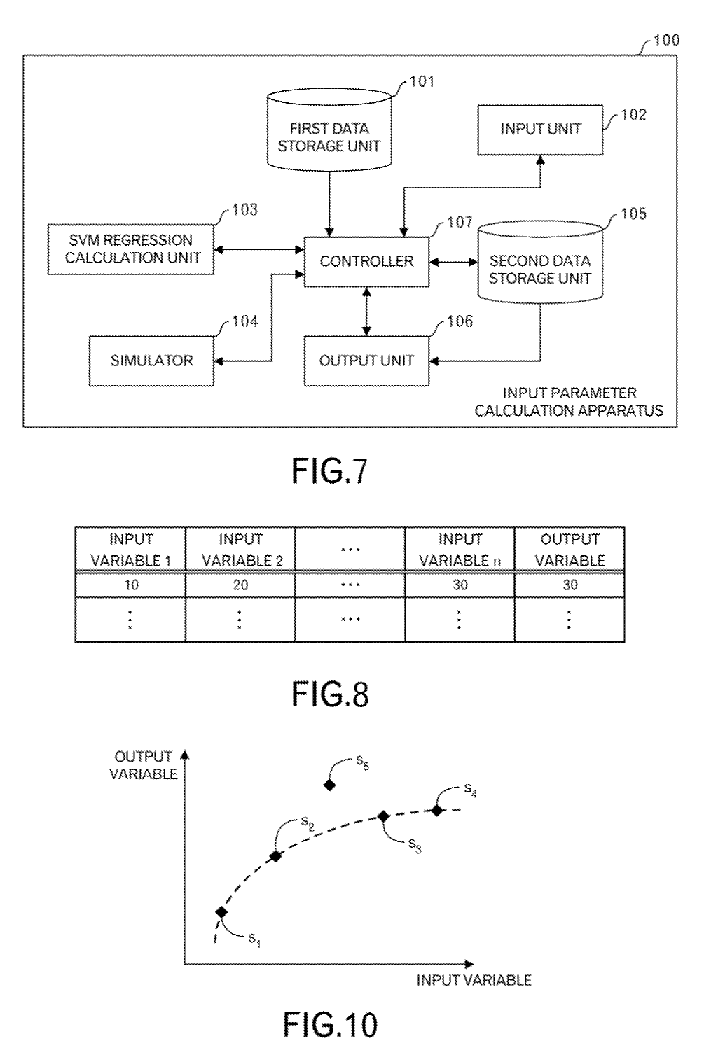

FIG. 7 illustrates a functional block diagram of an input parameter calculation apparatus 100 relating to this embodiment. The input parameter calculation apparatus 100 has a first data storage unit 101, input unit 102, Support Vector Machine (SVM) regression calculation unit 103, simulator 104, second data storage unit 105, output unit 106 and controller 107.

The first data storage unit 101 stores data as illustrated in FIG. 8, for example. Namely, the actually measured value data includes plural combinations of values of respective input variables (e.g. input variables 1 to n) and a value of an output variable.

The simulator 104 carries out a well-known simulation for the values of the input parameters and the values of the input variables, and outputs a value of the output variable as the processing result. The SVM regression calculation unit 103 carries out a well-known regression calculation by the Support Vector Machine for the values of the input variables and the value of the output variable, and outputs coefficient values as the regression calculation result. As for the Support Vector Machine, please refer to Nello Cristianini and John Shawe-Taylor “An Introduction to Support Vector Machines and other kernel-based learning methods”, Cambridge University Press 2000, ISBN 0521780195, for example.

The controller 107 uses data stored in the first data storage unit 101 to carry out a processing while cooperating with the SVM regression calculation unit 103 and simulator 104. Moreover, the controller 107 stores data during the processing and the processing results into the second data storage unit 105. Incidentally, the input unit 102 accepts inputs of data used for the processing from the user, and outputs the input data to the controller 107. The controller 107 carries out the processing according to the input data. The output unit 106 outputs data stored in the second data storage unit 105 in response to instructions from the controller 107.

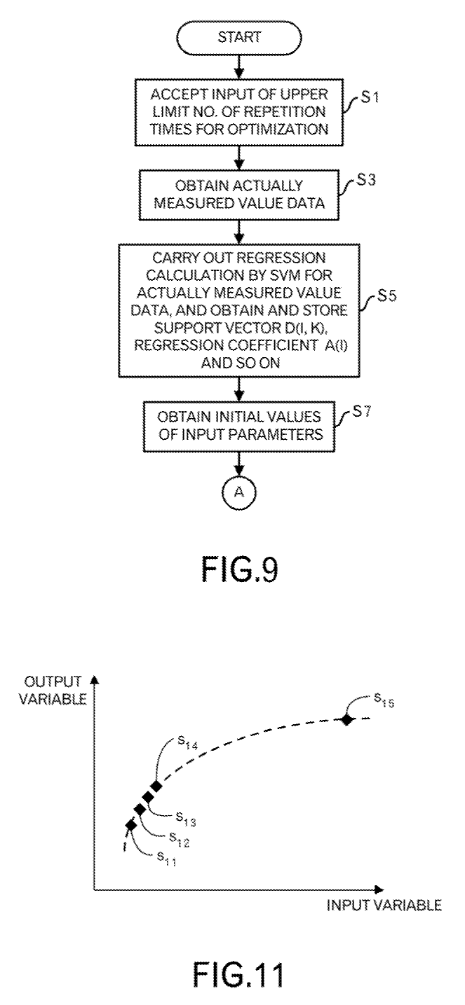

Next, processing contents of the input parameter calculation apparatus 100 as illustrated in FIG. 7 will be explained by using FIGS. 9 to 13.

The input unit 102 prompts the user to input the upper limit number of repetition times for the optimization, and when the input unit 102 accepts the input of the upper limit number of repetition times from the user, and the input unit 102 outputs the input data to the controller 107 (FIG. 9: step S1). The controller 107 accepts the upper limit number of repetition times. In addition, the controller 107 reads out the actually measured value data from the first data storage unit 101 (step S3). Then, the controller 107 outputs the actually measured value data to the SVM regression calculation unit 103, and causes the SVM regression calculation unit 103 to carry out the regression calculation by the Support Vector Machine for the actually measured value data.

In this embodiment, a following approximate expression is generated, for example.

$$Y 1 = {\sum }_{I} A ( I ) * exp ( - {\sum }_{K} {( X ( K ) - D ( I , K ) )}^{2} / {F ( I , K )}^{2} ) \qquad ( 1 )$$

K in the expression (1) represents an identification number of the input variable, and I represents an identification number of data. In addition, X(K) represents the input variable, Y1 represents the output variable, A(I) is a coefficient for the exponential function, and F(I, K) is a coefficient for the width of the exponential function. In such a case, the support vector is data D(I, K) in case of A(I)≠0. Incidentally, in case of A(I)=0, for the calculation of Y1, D(I, K) at that time is not used.

Namely, the support vector represents data samples that are important to approximate the relation between the input variables and the output variable. FIG. 10 schematically illustrates the support vector. In an example of FIG. 10, the vertical axis represents the output variable, the horizontal axis represents the input variable, and points s₁ to s₅ corresponding to the actually measured values are depicted. In such a case, the actually measured values s₁ to s₄ on the curve represented by a dotted line are identified as the data samples that are important to approximate the relation between the input variables and the output variable. On the other hand, the actually measured value s₅ that is considered as the abnormal value is a data sample that should be excluded when approximating the relation between the input variables and the output variable. Therefore, it is determined that it is not the support vector.

Similarly, in an example of FIG. 11, the density in the distribution of the actually measured values varies. However, according to the SVM, it is determined that the actually measured values s₁₂ and s₁₃ are not important on approximating the relation between the input variables and the output variable, and “0” is set to the corresponding coefficients A(I). Therefore, the actually measured values s₁₂ and s₁₃ do not correspond to the support vector.

Thus, the controller 107 obtains, as the regression calculation results, the coefficient values A(I) and F(I, K) and data D(I, K) in case of A(I)≠0 from the SVM regression calculation unit 103, and stores the obtained data into the second data storage unit 105 (step S5).

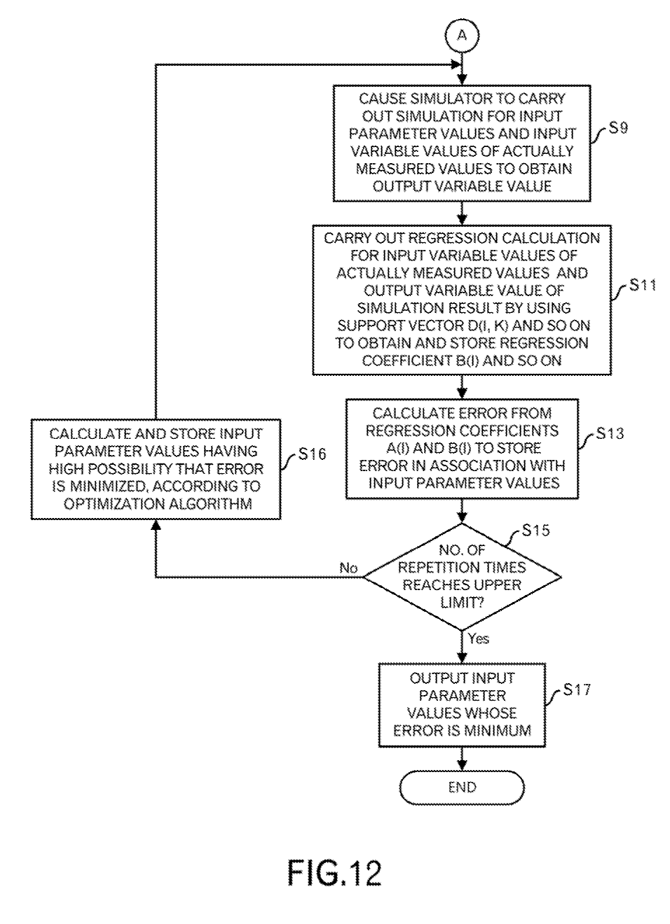

In addition, the controller 107 obtains initial values of the input parameters (step S7). The initial values of the input parameters may be inputted from the input unit 102 by the user, or may be generated by a random value generator, or may be preset. The processing shifts to a processing of FIG. 12 through a terminal A.

After shifting to the explanation of the processing of FIG. 12, the controller 107 outputs the input parameter values and the input variable values of the actually measured values to the simulator 104 to cause the simulator 104 to carry out the well-known simulation, and obtains the output variable value as the processing result, and stores the obtained data into the second data storage unit 105 (step S9). As illustrated in FIG. 8, because the plural combinations of the input variable values are prepared, the output variable value is obtained for each combination.

Furthermore, the controller 107 causes the SVM regression calculation unit 103 to execute the SVM regression calculation using the support vector D(I, K) and the like, which are obtained at the step S5, for the input variable values of the actually measured values and the output variable values of the simulation result, and obtains the regression coefficients B(I) and the like, as the results of the regression calculation, and stores the obtained data into the second data storage unit 105 (step S11).

In a first example of this embodiment, a following approximate expression is generated by the regression calculation, for example.

$$Y 2 = {\sum }_{I} B ( I ) * exp ( - {\sum }_{K} {( X ( K ) - D ( I , K ) )}^{2} / {F ( I , K )}^{2} ) \qquad ( 2 )$$

K in the expression (2) represents an identification number of the input variable, and I represents an identification number of data. In addition, X(K) represents the input variable, Y2 represents the output variable, B(I) is a coefficient for the exponential function, and F(I, K) is a coefficient for the width of the exponential function. In the first example, the value obtained at the step S5 is used for F(I, K) as it is. In addition, D(I, K) is a support vector, and is data D(I, K) in case of A(I)≠0.

On the other hand, in a second example of this embodiment, a following approximate expression is generated by the regression calculation, for example.

$$Y 2 = {\sum }_{I} B ( I ) * exp ( - {\sum }_{K} {( X ( K ) - D ( I , K ) )}^{2} / {G ( I , K )}^{2} ) \qquad ( 3 )$$

K in the expression (3) represents an identification number of the input variable, and I represents an identification number of data. In addition, X(K) represents the input variable, and Y2 represents the output variable, B(I) is a coefficient for the exponential function, G(I, K) is a coefficient for the width of the exponential function. In the second example, G (I, K) is calculated separately from F(I, K). Moreover, D(I, K) is a support vector and data D(I, K) in case of A(I)≠0.

Then, the controller 107 calculates an error from the regression coefficient A(I), regression coefficient B(I) and the like, and stores the error into the second data storage unit 105 in association with the input parameter values used this time (step S13).

In the first example of this embodiment, a following error is calculated.

$$\begin{matrix}E 1 = {\sum }_{I} {( A ( I ) - B ( I ) )}^{2} & ( 4 ) \\ E 2 = {\sum }_{I} {( ( A ( I ) - B ( I ) ) / A ( I ) )}^{2} & ( 5 )\end{matrix}$$

The error obtained from the expressions (4) and (5) is based on a total of squares of differences between the coefficient values for the exponential function.

On the other hand, in the second example of this embodiment, a following error is calculated.

$$E 3 = {\sum }_{I} {( ( A ( I ) - B ( I ) ) / A ( I ) )}^{2} + {\sum }_{I , K} {( ( F ( I , K ) - G ( I , K ) ) / F ( I , K ) )}^{2} \qquad ( 6 )$$

However, in the expression (6), a total is calculated in case of A(I)≠0 and F(I, K)≠0.

The expression (6) includes a value based on a square of the difference between the coefficients for the width of the exponential function in addition to the expression (5).

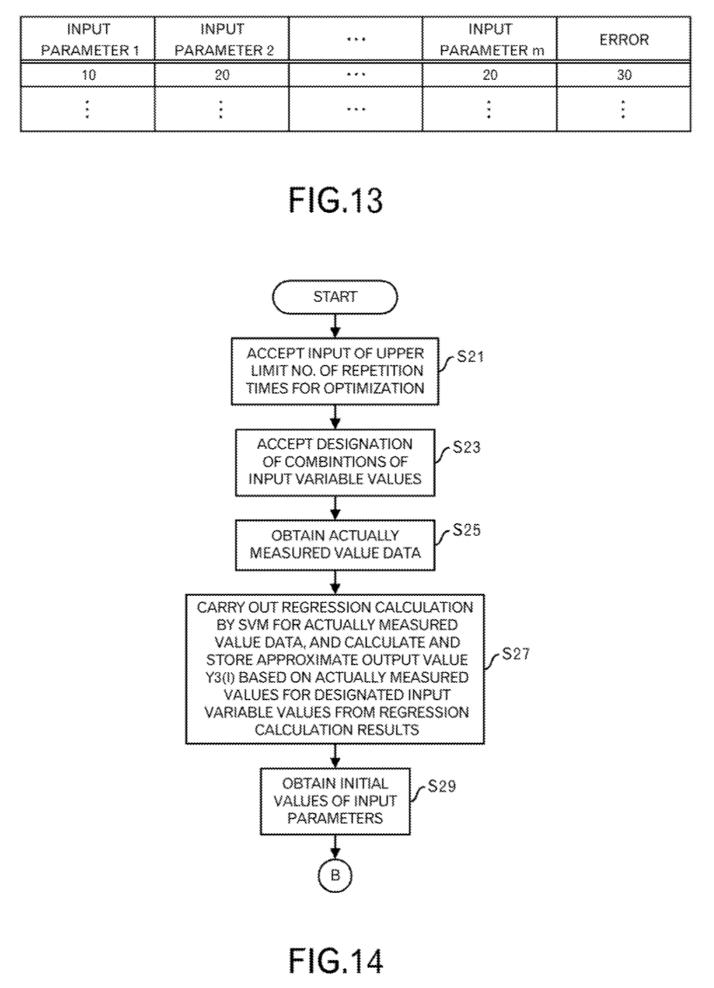

As the processing result of the step S13, data as illustrated in FIG. 13 is stored in the second data storage unit 105, for example. Specifically, values of the input parameters 1 to m and an error calculated when those input parameter values are used are registered. Data in one record is registered every time.

Then, the controller 107 determines whether or not the number of repetition times reaches the upper limit number of repetition times, which was inputted at the step S1 (step S15). When the number of repetition times does not reach the upper limit number of repetition times, the controller 107 calculates the input parameter values having high possibility that the error is minimized, according to the well-known optimization algorithm based on the input parameter values used up to this time and the calculated errors, and stores the calculated input parameter values into the second data storage unit 105 (step S16). As for the optimization algorithm, Nelder-Mead method, Powell method, BFGS method, conjugate gradient method, genetic algorithm, simulated annealing method, Differential Evolution method, Particle Swarm Optimization method and the like can be used. The processing contents of these methods are well-known. Therefore, further explanation is omitted. Then, the processing returns to the step S9.

On the other hand, when the number of repetition times reaches the upper limit number of repetition times, the controller 107 searches the errors stored in the second data storage unit 105 for the minimum value, identifies the input parameter values corresponding to the identified minimum error, stores the identified input parameter values into the second data storage unit 105, and outputs the identified input parameter values to the output unit 106. The output unit 106 outputs the input parameter values received from the controller 107 to a display device or the like (step S17). In addition, the input parameter values may be outputted to other computers connected through a network connected to the input parameter calculation apparatus 100. In addition, the input parameter values may be set to the simulator 104.

Because the aforementioned SVM regression calculation is carried out, the actually measured value data is processed after the smoothing or averaging even when the actually measured value data has the variation or offset or includes abnormal values. Therefore, it becomes possible to carry out an appropriate parameter fitting while suppressing the influence of the actually measured value data. Namely, because the error is calculated based on the coefficients in the approximate expression, which are obtained by the SVM regression calculation, it becomes possible to evaluate the degree of the parameter fitting in a form that the influence of the actually measured value data is suppressed.

More specifically, actually measured characteristic values are automatically and objectively selected among the actually measured plural values by analyzing the actually measured value data by SVM, and the error is calculated based on the actually measured characteristic values so as to avoid the bad influence of the variation, offset and abnormal values of the actually measured value data. Therefore, when the input parameter values that minimize the error are identified, the output variable values can be obtained by the computer simulation accurately.

### Embodiment 2

It is possible to deal with the offset of the actually measured values by adopting the SVM regression calculation. In this embodiment, the influence of the offset of the actually measured values is further suppressed.

The input parameter calculation apparatus relating to this embodiment has the same configuration as that illustrated in FIG. 7, though the processing contents are different. Therefore, the explanation is made by using the input parameter calculation apparatus 100 illustrated in FIG. 7.

Next, the processing contents in this embodiment will be explained by using FIGS. 14 to 17.

The input unit 102 prompts the user to input the upper limit number of repetition times for the optimization, accepts an input of the upper limit number of repetition times from the user, and outputs the input data to the controller 107 (FIG. 14: step S21). The controller 107 receives the upper limit number of repetition times. In addition, the input unit 102 prompts the user to designate a combination of the input variable values, and when the input unit 102 accepts the designation of the combination of the input variable values, the input unit 102 outputs the designated data to the controller 107 (step S23). The controller 107 stores the received combination of the input variable values into the second data storage unit 105. For example, plural values for one input variable are designated.

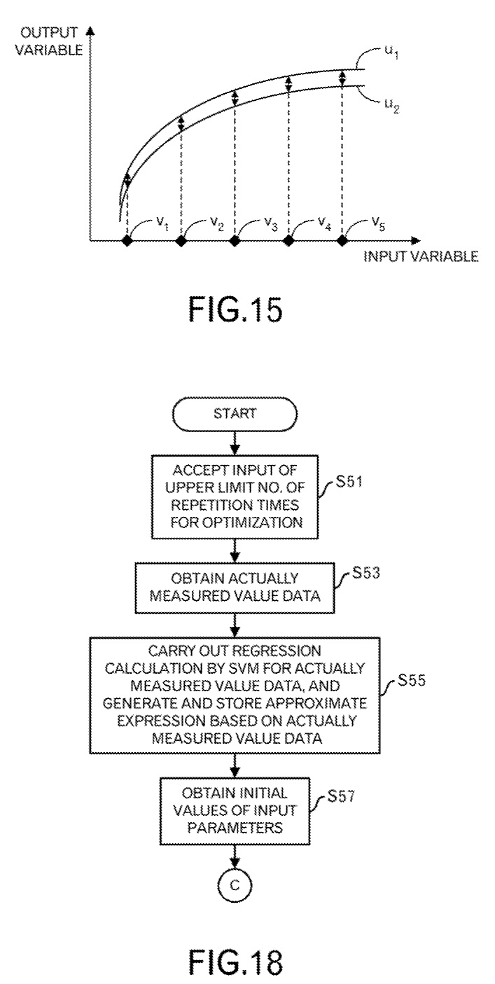

In this embodiment, as schematically illustrated in FIG. 15, as points for which the error should be calculated, input variable value v₁ to v₅ are designated. Then, an error between an approximate expression u₁ based on the actually measured value data and an approximate expression u₂ using simulation results that will be explained later is evaluated by the errors at the respective input variable values v₁ to v₅.

Then, the controller 107 reads out the actually measured value data from the first data storage unit 101 (step S25). After that, the controller 107 outputs the actually measured value data to the SVM regression calculation unit 103, and causes the SVM regression calculation unit 103 to carry out the regression calculation by the support vector machine for the actually measured value data. In this embodiment, an approximate expression like the expression (1) is generated.

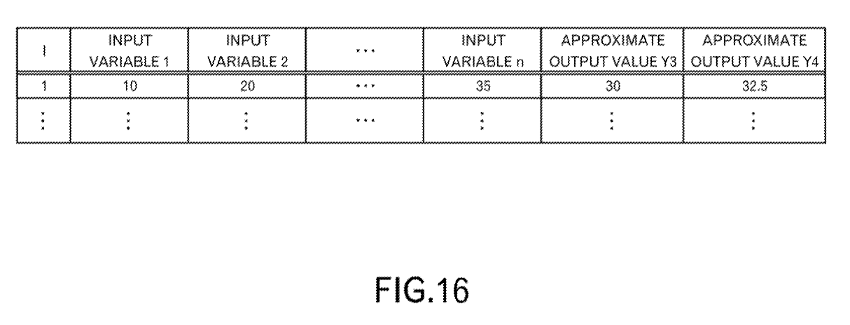

The controller 107 obtains coefficients A(I) and F(I, K) and data D(I, K) in case of A(I)≠0 as the regression calculation result from the SVM regression calculation unit 103, calculates approximate output values Y3(I) based on the actually measured values for the designated input variable values, from the approximate expression identified from these obtained data by substituting the designated input variable values into the approximate expression, and stores the calculated data into the second data storage unit 105 (step S27). For example, data as illustrated in FIG. 16 is stored in the second data storage unit 105. In an example of FIG. 16, values of the input variables 1 to n, an approximate output value Y3 based on the actually measured values, and an approximate output value Y4 based on the calculated value are stored. However, at this stage, the value of the approximate output value Y4 has not been stored. In addition, as schematically illustrated in FIG. 15, because plural points are set, plural records are stored as illustrated in FIG. 16.

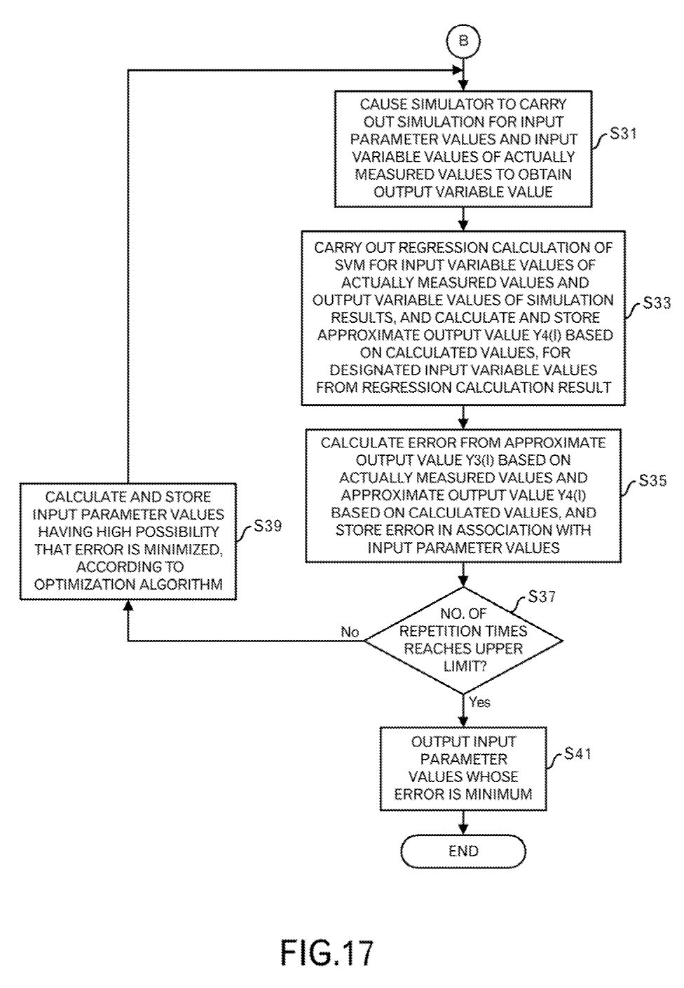

In addition, the controller 107 obtains initial values of the input parameters (step S29). The initial values of the input parameters may be inputted through the input unit 102 from the user, may be generated by the random number generator, or may be preset. The processing shifts to a processing of FIG. 17 through a terminal B.

Shifting to the explanation of the processing of FIG. 17, the controller 107 outputs the input parameter values and the input variable values of the actually measured values to the simulator 104 to cause the simulator 104 to carry out the well-known simulation, obtains the output variable value as the processing result from the simulator 104, and stores the obtained output variable value into the second data storage unit 105 (step S31). As illustrated in FIG. 8, because plural combinations of the input variable values are prepared, the output variable value is obtained for each combination.

Furthermore, the controller 107 causes the SVM regression calculation unit 103 to carry out the SVM regression calculation for the input variable values of the actually measured values and the output variable value of the simulation result. Then, an approximate expression like the expression (3) is obtained, for example. Then, the controller 107 obtains coefficient values B(I) and G(I, K) and data D(I, K) in case of B(I)≠0 as the regression calculation results from the SVM regression calculation unit 103, calculates approximate output values Y4(I), which are based on the calculated values, for the designated input variable values from the approximate expression identified from these obtained data, and stores the calculated data into the second data storage unit 105 (step S33).

As the regression calculation results, the regression coefficients B(I) and G(I, K) and data D(I, K) in case of B(I)≠0 are obtained, and the approximate output value Y4, which is based on the calculated value, for the designated input variable values is calculated from the approximate expression identified from these obtained data by substituting the designated input variable values into the approximate expression, and the approximate output value Y4 is stored in the second data storage unit 105. Here, in the example of FIG. 16, values are registered in the column of the approximate output value Y4.

Then, the controller 107 calculates an error from the approximate output values Y3(I), which are based on the actually measured values, and the approximate output values Y4(I), which are based on the calculated values, and stores the calculated error into the second data storage unit 105 in association with the input parameter values used this time (step S35).

For example, the error is calculated by an expression as follows:

$$E 4 = {\sum }_{I} {( Y 3 ( I ) - Y 4 ( I ) )}^{2} \qquad ( 7 )$$

This expression may be modified to a form that the expression is divided by Y3(I). Incidentally, I is an identification number of data.

Incidentally, the format of the data stored in the second data storage unit 105 at the step S35 is similar to the format as illustrated in FIG. 13, for example.

Then, the controller 107 determines whether or not the number of repetition times reaches the upper limit number of repetition times, which was inputted at the step S21 (step S37). When the number of repetition times does not reach the upper limit number of repetition times, the controller 107 calculates values of the input parameters having high possibility that the error is minimized, based on the input parameter values used up to this stage and the errors, according to the well-known optimization algorithm, and stores the calculated values into the second data storage unit 105 (step S39). As for the optimization algorithm, Nelder-Mead method, Powell method, BFGS method, conjugate gradient method, genetic algorithm, simulated annealing method, Differential Evolution method, Particle Swarm Optimization method and the like can be used. The processing contents at this step are already known. Therefore, further explanation is omitted. Then, the processing returns to the step S31.

On the other hand, when the number of repetition times reaches the upper limit number of repetition times, the controller 107 searches the error values stored in the second data storage unit 105 for the minimum value, identifies the input parameter values corresponding to the minimum error value, and stores the identified input parameter values into the second data storage unit 105, and outputs the identified value to the output unit 106. The output unit 106 outputs the input parameter values received from the controller 107, and outputs the values to the display device or the like (step S41). In addition, the output unit 106 may output the values to other computers connected through the network connected to the input parameter calculation apparatus 100, for example.

Thus, even when the offset and/or variation and/or abnormal values exists in the actually measured value data, the error is calculated from the approximate values of the output variable, which are obtained by the SVM regression calculation results based on the actually measured data, and the approximate values of the output variable, which are obtained by the SVM regression calculation results based on the simulation result. When the input parameter values minimizing such an error can be obtained, appropriate output variable values can be obtained in the computer simulation.

More specifically, by calculating the error representing the degree of the fitting between the actually measured values and the calculated values for the input variable values designated by the user, the user's experience and knowledge are reflected while suppressing the influence of the actually measured values, to enable the evaluation of the fitting.

### Embodiment 3

In the second embodiment, the combinations of the input variable values are set based on the user's experience and knowledge. However, there is a case where it is difficult for a user who does not have the experience so much to set appropriate combinations of the input variable values. Therefore, this embodiment deals with such a case.

The input parameter calculation apparatus relating to this embodiment has the same configuration as that illustrated in FIG. 7, though the processing contents are different. Therefore, the explanation is made by using the input parameter calculation apparatus 100 illustrated in FIG. 7.

Next, the processing contents of this embodiment will be explained by using FIGS. 18 to 21.

The input unit 102 prompts the user to input the upper limit number of repetition times for the optimization, accepts an input of the upper limit number of repetition times from the user, and outputs the input data to the controller 107 (FIG. 18: step S51). The controller 107 receives the upper limit number of repetition times. Then, the controller 107 reads out the actually measured value data from the first data storage unit 101 (step S53).

After that, the controller 107 outputs the actually measured value data to the SVM regression calculation unit 103, and causes the SVM regression calculation unit 103 to carry out the regression calculation by the support vector machine for the actually measured value data. In this embodiment, an approximate expression like the expression (1) is generated.

The controller 107 obtains coefficient values A(I) and F(I, K) and data D(I, K) in case of A(I)≠0, as the regression calculation results, from the SVM regression calculation unit 103, and stores the obtained data into the second data storage unit 105 as data concerning the approximate expression, which is based on the actually measured value data (step S55).

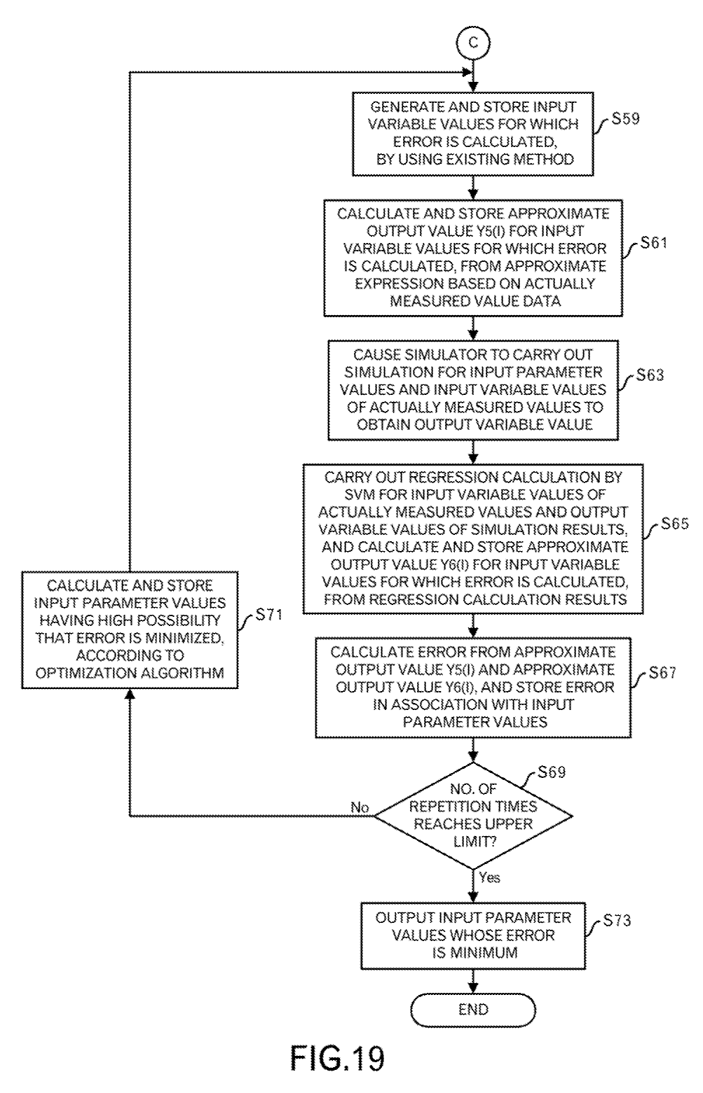

Moreover, the controller 107 obtains the initial values of the input parameters (step S57). The initial values of the input parameters may be inputted through the input unit 102 from the user, may be generated by the random number generator, or may be preset. The processing shifts to a processing of FIG. 19 through a terminal C.

Shifting to the explanation of the processing of FIG. 19, the controller 107 generates plural combinations of the input variable values for which the error is calculated, by using an existing method such as Experimental design, Latin Hypercube Sampling, or random sampling, and stores the data of the plural combinations into the second data storage unit 105 (step S59).

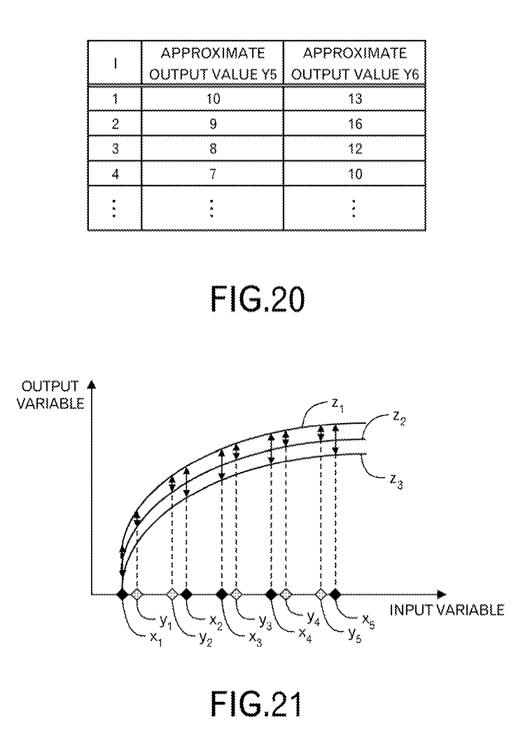

Then, the controller 107 substitutes the input variable values for which the error is calculated into the approximate expression, which is based on the actually measured value and generated at the step S55, to calculate an approximate output value Y5(I) for the input variable values for which the error is calculated, and stores the calculated value into the second data storage unit 105 (step S61). For example, data as illustrated in FIG. 20 is stored in the second data storage unit 105. In an example of FIG. 20, for each combination of the input variable values for which the error is calculated, the approximate output value Y5 and an approximate output value Y6, which will be calculated later, are stored.

Furthermore, the controller 107 outputs the input parameter values and the input variable values of the actually measured values to the simulator 104 to cause the simulator 104 to carry out the well-known simulation, and obtains the output variable value as the processing result from the simulator 104, and stores the obtained data into the second data storage unit 105 (step S63). As illustrated in FIG. 8, because plural combinations of the input variable values are prepared, the output variable value can be obtained for each combination.

In addition, the controller 107 causes the SVM regression calculation unit 103 to execute the SVM regression calculation for the input variable values of the actually measured values and the output variable value as the simulation result. Then, the approximate expression like the expression (3) can be obtained, for example. Then, the controller 107 obtains the coefficient values B(I) and G(I, K) and data D(I, K) in case of B(I)≠0, as the regression calculation results, from the SVM regression calculation unit 103, calculates an approximate output value Y6(I) by substituting the input variable values for which the error is calculated into an approximate expression identified from these obtained data, and stores the calculated data into the second data storage unit 105 (step S65). Data as illustrated in FIG. 20 is stored.

Then, the controller 107 calculates the error from the approximate output value Y5(I) and the approximate output value Y6(I), and stores the calculated error into the second data storage unit 105 in association with the input parameter values used this time (step S67).

For example, the error is calculated by the following expression.

$$E 5 = {\sum }_{I} {( Y 5 ( I ) - Y 6 ( I ) )}^{2} \qquad ( 8 )$$

The expression may be modified in a form that the expression is divided by Y5(I). Incidentally, I is an identification number of data.

Incidentally, the format of data stored in the second data storage unit 105 at the step S67 is similar to the format as illustrated in FIG. 13, for example.

Then, the controller 107 determines whether or not the number of repetition times reaches the upper limit number of repetition times, which was inputted at the step S51 (step S69). When the number of repetition times does not reach the upper limit number of repetition times, the controller 107 calculates the input parameter values having high possibility that the error is minimized, according to the well-known optimization algorithm based on the input parameter values used up to this time and the calculated errors, and stores the calculated input parameter values into the second data storage unit 105 (step S71). As for the optimization algorithm, Nelder-Mead method, Powell method, BFGS method, conjugate gradient method, genetic algorithm, simulated annealing method, Differential Evolution method, Particle Swarm Optimization method and the like can be used. The processing contents of these methods are well-known. Therefore, further explanation is omitted. Then, the processing returns to the step S59.

On the other hand, when the number of repetition times reaches the upper limit number of repetition times, the controller 107 searches the errors stored in the second data storage unit 105 for the minimum value, identifies the input parameter values corresponding to the identified minimum error, stores the identified input parameter values into the second data storage unit 105, and outputs the identified input parameter values to the output unit 106. The output unit 106 outputs the input parameter values received from the controller 107 to a display device or the like (step S73). In addition, the input parameter values may be outputted to other computers connected through a network connected to the input parameter calculation apparatus 100.

Thus, at the step S59, the input variable value for which the error is calculated is regenerated for each repetition. As schematically illustrated in FIG. 21, when a curve z₂ is drawn by the SVM regression calculation by the input parameter value “10”, for example, an error for corresponding points on the curve z₁ is calculated for the generated input variable values y₁ to y₅. On the other hand, when a curve z₃ is drawn by the input parameter value “20”, an error for corresponding points on the curve z₁ is calculated for the regenerated input variable values x₁ to x₅.

Thus, because the input variable values for which the error is calculated do not have any offset, the evaluation of the fitting is carried out without any bias, and much appropriate input parameter values are identified. Namely, even when the actually measured value data has the offset and/or the variation, the input variable values, which are equally set, can be used. Therefore, appropriate evaluation of the fitting can be made.

Although the embodiments of this technique were explained, this technique is not limited to these embodiments. Especially, as for the apparatus configuration, the input parameter calculation apparatus 100 illustrated in FIG. 7 is a mere example, and the aforementioned functions may be implemented by plural computers. For example, the simulator 104 and/or SVM regression calculation unit 103 may be respectively implemented in one or plural computers, and the controller 107 may be implemented independently as a management computer.

In addition, as long as the processing results do not change, an order of the steps may be exchanged or the steps may be executed in parallel.

Furthermore, the expressions of the error may be modified along with the aforementioned point.

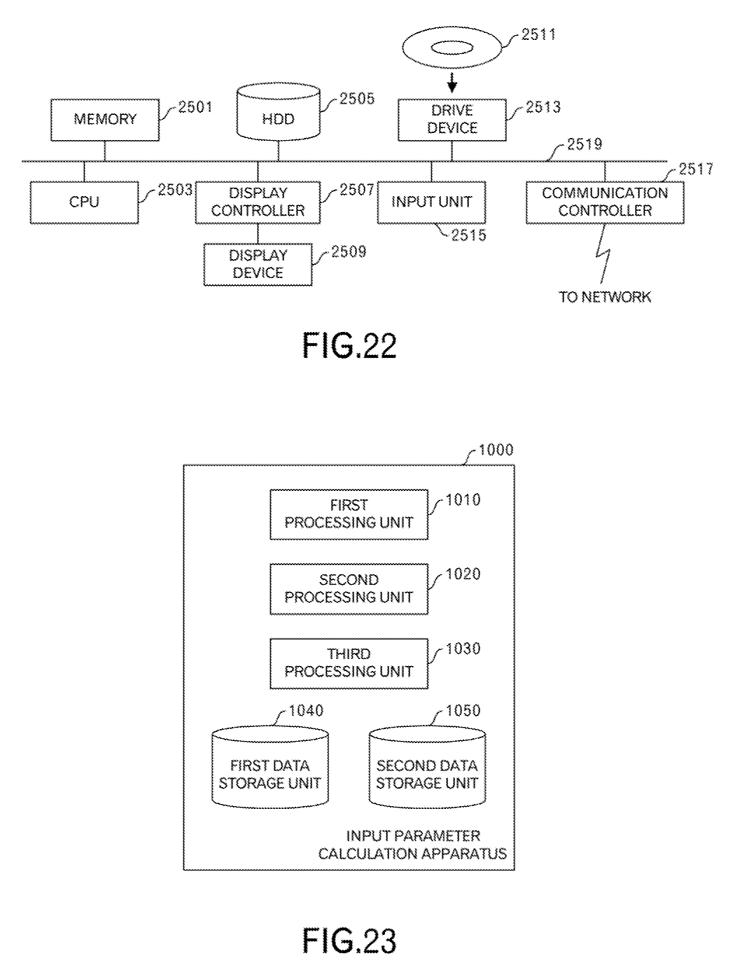

In addition, the input parameter calculation apparatus 100 is a computer device as shown in FIG. 22. That is, a memory 2501 (storage device), a CPU 2503 (processor), a hard disk drive (HDD) 2505, a display controller 2507 connected to a display device 2509, a drive device 2513 for a removable disk 2511, an input device 2515, and a communication controller 2517 for connection with a network are connected through a bus 2519 as shown in FIG. 22. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform necessary operations. Besides, intermediate processing data is stored in the memory 2501, and if necessary, it is stored in the HDD 2505. In this embodiment of this technique, the application program to realize the aforementioned functions is stored in the computer-readable, non-transitory removable disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the necessary application programs systematically cooperate with each other, so that various functions as described above in details are realized.

The aforementioned embodiments are summarized as follows:

According to a first aspect of the embodiments, a method for calculating values of input parameters includes: calculating a support vector and first regression coefficient values by carrying out a regression calculation of a support vector machine for values of input variables and first values of an output variable; and calculating the values of the input parameters, which are to be used for a simulation, so as to minimize an error calculated from the first regression coefficient values and second regression coefficient values, wherein the second regression coefficient values are obtained by the regression calculation of the support vector machine using the calculated support vector for second values of the output variable and the values of the input variables, and the second values of the output variable are obtained from the simulation for the values of the input variables.

By using the support vector machine, it is possible to avoid a problem such as the variation, offset values and/or abnormal values of the measurement. Especially, because the support vector is used, appropriate sample points are automatically extracted, and an appropriate approximate expression is derived based on the sample points. Namely, the input parameter values minimizing the error are identified based on such an appropriate approximate expression.

According to a second aspect of the embodiments, a method for calculating values of input parameters includes: calculating a first approximate expression by carrying out a regression calculation of a support vector machine for first values of input variables and first values of an output variable; calculating second values of the output variable by substituting second values of the input variables into the first approximate expression; and calculating the values of the input parameters, which are to be used for a simulation, so as to minimize an error calculated from the second values of the output variable and third values of the output variable, wherein the third values are obtained by substituting the second values of the input variables into a second approximate expression, and the second approximate expression is obtained by the regression calculation of the support vector machine for the first values of the input variables and fourth values of the output variable, which are obtained from the simulation for the first values of the input variables.

By appropriately designating the second values of the input variables, it becomes possible to evaluate the errors at appropriate points, namely, evaluate the fitting to the measurement values. That is, it becomes possible to evaluate the fitting to the measurement values while suppressing the influence of the variation and/or offset and/or abnormal values of the measurement values.

According to a third aspect of the embodiments, a method for calculating values of input parameters includes: calculating a first approximate expression by carrying out a regression calculation of a support vector machine for first values of input variables and first values of an output variable; and calculating the values of the input parameters, which are to be used for a simulation, while randomly changing second values of the input variables so as to minimize an error calculated from second values of the output variable and third values of the output variable, wherein the second values of the output variable are obtained by substituting the second values of the input variables into an second approximate expression calculated by the regression calculation of the support vector for the first values of the input variables and fourth values of the output variable, and the fourth values of the output variable are obtained from the simulation for the first values of the input variables, and the third values of the output variable are calculated by substituting the second values of the input variables into the first approximate expression.

Because the second values of the input variables are randomly changed, it becomes possible to evaluate the fitting to the measurement values in the entire space, equally. That is, it is possible to evaluate the fitting to the measurement values while suppressing the variation and/or the offset and/or abnormal values of the measurement values.

Incidentally, in the first aspect, the first regression coefficient values may include a first functional coefficient value for a first exponential function and a first width coefficient value for a width of the first exponential function, and the second regression coefficient values may include a second functional coefficient value for a second exponential function and a second width coefficient value for a width of the second exponential function. In such a case, the aforementioned error may be calculated by summing an error with respect to the first functional coefficient value and the second functional coefficient value and an error with respect to the first width coefficient value and the second width coefficient value. By doing so, it is possible to calculate much accurate error.

An input parameter calculation apparatus (FIG. 23) relating to a fourth aspect of the embodiments has a first processing unit (FIG. 23: 1010) that carries out a regression calculation of a support vector machine; a second processing unit (FIG. 23: 1020) that carries out a simulation; and a third processing unit (FIG. 23: 1030) that cooperates with the first processing unit and the second processing unit. Then, the third processing unit obtains a support vector and first regression coefficient values by causing the first processing unit to carry out a regression calculation of a support vector machine for data stored in a first data storage unit (FIG. 23: 1040) storing values of input variables and first values of an output variable, and stores the support vector and the first regression coefficient values into a second data storage unit (FIG. 23: 1050); and calculates values of input parameters, which are to be used for a simulation by the second processing unit, so as to minimize an error calculated from the first regression coefficient values stored in the second data storage unit and second regression coefficient values, and stores the values of the input parameters into the second data storage unit, wherein the second regression coefficient values are obtained by the regression calculation of the support vector machine using the support vector, which is stored in the second data storage unit, for second values of the output variable and the values of the input variables, which are stored in the first data storage unit, and the second values of the output variable are obtained from the simulation by the second processing unit for the values of the input variables.

An input parameter calculation apparatus relating to a fifth aspect of the embodiments has a first processing unit that carries out a regression calculation of a support vector machine; a second processing unit that carries out a simulation; and a third processing unit that cooperates with the first processing unit and the second processing unit. Then, the third processing unit obtains a first approximate expression by causing the first processing unit to carry out a regression calculation of a support vector machine for data stored in a first data storage unit storing first values of input variables and first values of an output variable; calculates second values of the output variable by substituting second values of the input variables into the first approximate expression, and stores the second values of the output variable into a second data storage unit; and calculates values of input parameters, which are to be used for a simulation by the second processing unit, so as to minimize an error calculated from the second values of the output variable, which are stored in the second data storage unit, and third values of the output variable, and stores the values of the input parameters into the second data storage unit. The third values are obtained by substituting the second values of the input variables into a second approximate expression, and the second approximate expression is obtained by the regression calculation of the support vector machine by the first processing unit for the first values of the input variables, which are stored in the first data storage unit, and fourth values of the output variable, which are obtained from the simulation by the second data storage unit, for the first values of the input variables, which are stored in the first data storage unit.

An input parameter calculation apparatus relating to a sixth aspect of the embodiments has a first processing unit that carries out a regression calculation of a support vector machine; a second processing unit that carries out a simulation; and a third processing unit that cooperates with the first processing unit and the second processing unit. Then, the third processing unit obtains a first approximate expression by causing the first processing unit to carry out a regression calculation of a support vector machine for data stored in a first data storage unit storing first values of input variables and first values of an output variable, and stores the first approximate expression into a second storage unit; and calculates values of input parameters, which are to be used for a simulation by the second processing unit, while randomly changing second values of the input variables so as to minimize an error calculated from second values of the output variable and third values of the output variable, and stores the values of the input parameters into the second data storage unit. The second values of the output variable are obtained by substituting the second values of the input variables into an second approximate expression calculated by the regression calculation of the support vector machine by the first processing unit for the first values of the input variables, which are stored in the first data storage unit, and fourth values of the output variable, and the fourth values of the output variable are obtained from the simulation by the second processing unit for the first values of the input variables, which are stored in the first data storage unit, and the third values of the output variable are calculated by substituting the second values of the input variables into the first approximate expression, which is stored in the second data storage unit.

Incidentally, it is possible to create a program causing a computer to execute the aforementioned processing, and such a program is stored in a computer readable storage medium or storage device such as a flexible disk, CD-ROM, DVD-ROM, magneto-optic disk, a semiconductor memory, and hard disk. In addition, the intermediate processing result is temporarily stored in a storage device such as a main memory or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A computer-readable, non-transitory storage medium storing a program for causing a computer to execute a procedure, the procedure comprising:
calculating a support vector and first regression coefficient values by carrying out a regression calculation of a support vector machine for values of input variables and first values of an output variable; and
calculating values of input parameters, which are to be used for a simulation, so as to minimize an error calculated from the first regression coefficient values and second regression coefficient values, wherein the second regression coefficient values are obtained by the regression calculation of the support vector machine using the calculated support vector for second values of the output variable and the values of the input variables, and the second values of the output variable are obtained from the simulation for the values of the input variables.

2. A computer-readable, non-transitory storage medium storing a program for causing a computer to execute a procedure, the procedure comprising:
calculating a first approximate expression by carrying out a regression calculation of a support vector machine for first values of input variables and first values of an output variable;
calculating second values of the output variable by substituting second values of the input variables into the first approximate expression; and
calculating values of input parameters, which are to be used for a simulation, so as to minimize an error calculated from the second values of the output variable and third values of the output variable, wherein the third values are obtained by substituting the second values of the input variables into a second approximate expression, and the second approximate expression is obtained by the regression calculation of the support vector machine for the first values of the input variables and fourth values of the output variable, which are obtained from the simulation for the first values of the input variables.

3. A computer-readable, non-transitory storage medium storing a program for causing a computer to execute a procedure, the procedure comprising:
calculating a first approximate expression by carrying out a regression calculation of a support vector machine for first values of input variables and first values of an output variable; and
calculating values of input parameters, which are to be used for a simulation, while randomly changing second values of the input variables so as to minimize an error calculated from second values of the output variable and third values of the output variable, wherein the second values of the output variable are obtained by substituting the second values of the input variables into an second approximate expression calculated by the regression calculation of the support vector machine for the first values of the input variables and fourth values of the output variable, and the fourth values of the output variable are obtained from the simulation for the first values of the input variables, and the third values of the output variable are calculated by substituting the second values of the input variables into the first approximate expression.

4. The computer-readable, non-transitory storage medium as set forth in claim 1, wherein the first regression coefficient values include a first functional coefficient value for a first exponential function and a first width coefficient value for a width of the first exponential function, and the second regression coefficient values include a second functional coefficient value for a second exponential function and a second width coefficient value for a width of the second exponential function, and the error is calculated by summing an error with respect to the first functional coefficient value and the second functional coefficient value and an error with respect to the first width coefficient value and the second width coefficient value.

5. A method for calculating values of input parameters, the method comprising:
calculating, by using a computer, a support vector and first regression coefficient values by carrying out a regression calculation of a support vector machine for values of input variables and first values of an output variable; and
calculating, by using the computer, the values of the input parameters, which are to be used for a simulation, so as to minimize an error calculated from the first regression coefficient values and second regression coefficient values, wherein the second regression coefficient values are obtained by the regression calculation of the support vector machine using the calculated support vector for second values of the output variable and the values of the input variables, and the second values of the output variable are obtained from the simulation for the values of the input variables.

6. A method for calculating values of input parameters, the method comprising:
calculating, by using a computer, a first approximate expression by carrying out a regression calculation of a support vector machine for first values of input variables and first values of an output variable;
calculating, by using the computer, second values of the output variable by substituting second values of the input variables into the first approximate expression; and
calculating, by using the computer, the values of the input parameters, which are to be used for a simulation, so as to minimize an error calculated from the second values of the output variable and third values of the output variable, wherein the third values are obtained by substituting the second values of the input variables into a second approximate expression, and the second approximate expression is obtained by the regression calculation of the support vector machine for the first values of the input variables and fourth values of the output variable, which are obtained from the simulation for the first values of the input variables.

7. A method for calculating values of input parameters, the method comprising:
calculating, by using a computer, a first approximate expression by carrying out a regression calculation of a support vector machine for first values of input variables and first values of an output variable; and
calculating, by using the computer, the values of the input parameters, which are to be used for a simulation, while randomly changing second values of the input variables so as to minimize an error calculated from second values of the output variable and third values of the output variable, wherein the second values of the output variable are obtained by substituting the second values of the input variables into an second approximate expression calculated by the regression calculation of the support vector for the first values of the input variables and fourth values of the output variable, and the fourth values of the output variable are obtained from the simulation for the first values of the input variables, and the third values of the output variable are calculated by substituting the second values of the input variables into the first approximate expression.

8. An apparatus for calculating values of input parameters, the apparatus comprising:
a storage unit storing values of input variables and first values of an output variable; and
a processor configured to execute a procedure, comprising:
calculating a support vector and first regression coefficient values by carrying out a regression calculation of a support vector machine for the values of the input variables and the first values of the output variable, which are stored in the storage unit; and
calculating the values of the input parameters, which are to be used for a simulation, so as to minimize an error calculated from the first regression coefficient values and second regression coefficient values, wherein the second regression coefficient values are obtained by the regression calculation of the support vector machine using the calculated support vector for second values of the output variable and the values of the input variables, and the second values of the output variable are obtained from the simulation for the values of the input variables.

9. An apparatus for calculating values of input parameters, the apparatus comprising:
a storage unit storing first values of input variables and first values of an output variable; and
a processor configured to execute a procedure, comprising:
calculating a first approximate expression by carrying out a regression calculation of a support vector machine for the first values of the input variables and the first values of the output variable, which are stored in the storage unit;
calculating second values of the output variable by substituting second values of the input variables into the first approximate expression; and
calculating the values of the input parameters, which are to be used for a simulation, so as to minimize an error calculated from the second values of the output variable and third values of the output variable, wherein the third values are obtained by substituting the second values of the input variables into a second approximate expression, and the second approximate expression is obtained by the regression calculation of the support vector machine for the first values of the input variables and fourth values of the output variable, which are obtained from the simulation for the first values of the input variables.

10. An apparatus for calculating values of input parameters, the apparatus comprising:
a storage unit storing first values of input variables and first values of an output variable;
a processor configured to execute a procedure, comprising:
calculating a first approximate expression by carrying out a regression calculation of a support vector machine for the first values of the input variables and the first values of the output variable, which are stored in the storage unit; and
calculating the values of the input parameters, which are to be used for a simulation, while randomly changing second values of the input variables so as to minimize an error calculated from second values of the output variable and third values of the output variable, wherein the second values of the output variable are obtained by substituting the second values of the input variables into an second approximate expression calculated by the regression calculation of the support vector for the first values of the input variables and fourth values of the output variable, and the fourth values of the output variable are obtained from the simulation for the first values of the input variables, and the third values of the output variable are calculated by substituting the second values of the input variables into the first approximate expression.
